(19) United States
(12) Patent Application Publication
(10) Pub. No.: US 2008/0002033 A1
(43) Pub. Date: Jan. 3, 2008

(54) Image-capture apparatus, camera control unit, video camera system, and method of transmitting control information

(76) Inventors: Yujiro Ito, Kanagawa (JP); Hidekazu Suto, Tokyo (JP)

Correspondence Address: FROMMER LAWRENCE & HAUG LLP, 745 FIFTH AVENUE, NEW YORK, NY, 10151, US

(21) Appl. No.: 11/823,419

(22) Filed: Jun. 27, 2007

(30) Foreign Application Priority Data
Jun. 30, 2006 (JP) P2006-182569

(51) Int. Cl. H04N 5/232; H04N 5/228

(52) U.S. Cl. 348/211.99; 348/222.1; 348/345; 348/E05.042; 348/E05.031

(57) ABSTRACT

An image-capture apparatus having an intercom connecting unit and having an autofocus mechanism, capable of voice communication with an external camera control unit through an intercom connected to the intercom connecting unit includes: an image-capture unit, an image signal processor, a control unit and a transmitting unit. The image-capture unit captures an image of a subject and converts the image into an image signal. The image signal processor performs processing on the signal from the image-capture unit. The control unit determines whether the subject is in focus and generates a command signal based on a result of the determination. The transmitting unit multiplexes an image signal from the processor with a control information signal including the command signal from the control unit based on the result of the determination and status information indicating a state of the image-capture apparatus and transmits multiplexed signals to the camera control unit.

### CROSS REFERENCES TO RELATED APPLICATIONS

The present invention contains subject matter related to Japanese Patent Application JP 2006-182569 filed in the Japanese Patent Office on Jun. 30, 2006, the entire contents of which being incorporated herein by reference.

### BACKGROUND OF THE INVENTION

1. Field of the Invention

The present invention relates to a video camera system and a method of transmitting control information, which are suitably applied to a press-use or professional-use video camera system, and an image-capture apparatus and a camera control unit to be applied in such a system.

2. Description of the Related Art

In recent years, video cameras have been influenced by the expansion of HD (High Definition) broadcasting and those capable of imaging with HD have become popular. An HD-video camera is capable of obtaining a high-definition image but difficult in focusing of a lens by just that much. The resolution of HD has a pixel pitch shorter than that of the resolution of the existing SD (Standard Definition). Thus, a focal depth may be shortened even at the same brightness (F value) and focal distance of a lens as those at the time of imaging with SD. The term “focal depth” refers to as a range of image distances corresponding to the vicinity of an object distance included in depth of field. In other words, it refers to as a distance between a lens and an imaging area, at which the focused image of the subject is allowed within an acceptable range of sharpness. Accordingly, in the case where an image is defocused at the same distance as that of the imaging with SD, blurring increases more than that of the imaging with SD. Thus, work of careful focusing is desired.

Therefore, broadcast video cameras have become expected to have auto-focusing functions. In fact, some broadcast video cameras having autofocus mechanisms have come out in the market. However, the focusing of a video camera with an autofocus mechanism still admits of improvement and may be less accurate. Therefore, photographers should constantly watch whether their video cameras are out of focus during shooting even though the video cameras have built-in autofocus mechanisms.

Furthermore, the photographers should pay attention to many matters, such as exposure, color tone, and composition, in addition to the state of focusing. Thus, a method for efficiently passing information of these matters on the photographers has been expected to be devised.

Japanese Unexamined Patent Application Publication No. H10-304234 discloses that information a photographer should look out for, including various kinds of configuration information and a battery level, is indicated on the display of a head set on the photographer by representation of symbols, characters, or the like together with an image shot by the video camera.

### SUMMARY OF THE INVENTION

Furthermore, monitors themselves, such as viewfinders, mounted on video cameras may be not acceptable to high definition. Even if a photographer is often in a situation of paying attention to the state of focusing, there is a problem of difficulty in determining whether a shot image with HD is out of focus.

According to an embodiment of the present invention, in the case where control information is transmitted between an image-capture apparatus and a camera control unit for controlling the image-capture apparatus, the image-capture apparatus determines whether the subject is in focus to generate a command signal on the basis of a result of the determination, multiplexes an image signal with a control information signal including a command signal and status information for indicating a state of the image-capture apparatus, and transmits multiplexed signals to the camera control unit. The camera control unit receives the multiplexed signals and extracts from the received multiplexed signals a command signal on the basis of the result of determining whether the subject is in focus, and performing a warning in response to the command signal.

As described above, the command signal generated on the basis of determining whether the subject is in focus, which is performed on the image-capture apparatus, is also transmitted to the camera control unit. Thus, the camera control unit is allowed to notify information about the certainty of determining whether the subject is in focus by display or sound.

According to an embodiment of the present invention, in the case where the image-capture apparatus generates a warning command signal on the basis of the result of determining whether the subject is in focus, warning information is also notified to the camera control unit by displaying the warning information on a viewfinder and emitting a warning sound through an intercom headphone. Therefore, the waning information may be more surely notified to a photographer.

### BRIEF DESCRIPTION OF THE DRAWINGS

FIG. 1 is a schematic diagram illustrating an example of the connection of a video camera to a CCU according to an embodiment of the present invention;

FIG. 2 is a block diagram illustrating a configuration example of a video camera and a CCU according to an embodiment of the present invention;

FIG. 3 is a diagram illustrating a configuration of an evaluation value calculator according to an embodiment of the present invention;

FIG. 4 is a diagram illustrating regions used for evaluating an image for according to an embodiment of the present invention;

FIG. 5 is a diagram illustrating a configuration of a horizontal-direction evaluation value calculation filter according to an embodiment of the present invention;

FIG. 6 is a diagram illustrating a configuration of a horizontal-direction evaluation value calculation filter with a whole integration system according to an embodiment of the present invention;

FIG. 7 is a diagram illustrating a configuration of a vertical direction evaluation value calculation filter according to an embodiment of the present invention;

FIGS. 8A, 8B, and 8C are graphs respectively illustrating fluctuations of luminance addition values, evaluation values, and movement of the focus lens when auto-focus processing normally or successfully terminates according to an embodiment of the present invention;

FIGS. 9A, 9B, and 9C are graphs respectively illustrating fluctuations of luminance addition values, evaluation values, and movement of the focus lens when auto-focus processing fails to normally or successfully terminate according to an embodiment of the present invention;

FIG. 10 is a graph illustrating an example of evaluation values with which whether a subject image is in-focus or out-of-focus can be determined according to an embodiment of the present invention;

FIG. 11 is a graph illustrating an example of evaluation values with which whether a subject image is in-focus or out-of-focus cannot be determined according to an embodiment of the present invention;

FIGS. 12A and 12B are graphs illustrating processes in determining whether a subject image is in-focus or out-of-focus using luminance addition values and evaluation values according to an embodiment of the present invention;

FIG. 13 is a flowchart illustrating an auto-focus processing according to an embodiment of the present invention;

FIG. 14 is a flowchart illustrating background processing according to an embodiment of the present invention;

FIGS. 15A and 15B are first graphs respectively illustrating fluctuations of evaluation values and movement of the focus lens when auto-focus processing fails to terminate according to an embodiment of the present invention;

FIGS. 16A and 16B are graphs illustrating fluctuations of evaluation values due to presence or absence of a decrease in SNR;

FIGS. 17A and 17B are second graphs respectively illustrating fluctuations of evaluation values and movement of the focus lens when auto-focus processing fails to terminate according to an embodiment of the present invention;

FIG. 18 is a flowchart illustrating an auto-focus processing according to an embodiment of the present invention;

FIG. 19 is a flowchart illustrating a process example of transmitting the result of a determination of whether the subject is in focus in a video camera according to an embodiment of the present invention;

FIG. 20 is a flowchart illustrating a process example of extracting various kinds of command signals in a CCU according to an embodiment of the present invention;

FIG. 21 is a flowchart illustrating a process example of transmitting information for the material of determining whether the subject is in focus in a video camera according to another embodiment of the present invention; and

FIG. 22 is a flowchart illustrating a process example of determining whether the subject is in focus in a CCU according to another embodiment of the present invention.

### DESCRIPTION OF THE PREFERRED EMBODIMENTS

Hereinafter, an embodiment of the present invention will be described in detail with reference to the attached drawings.

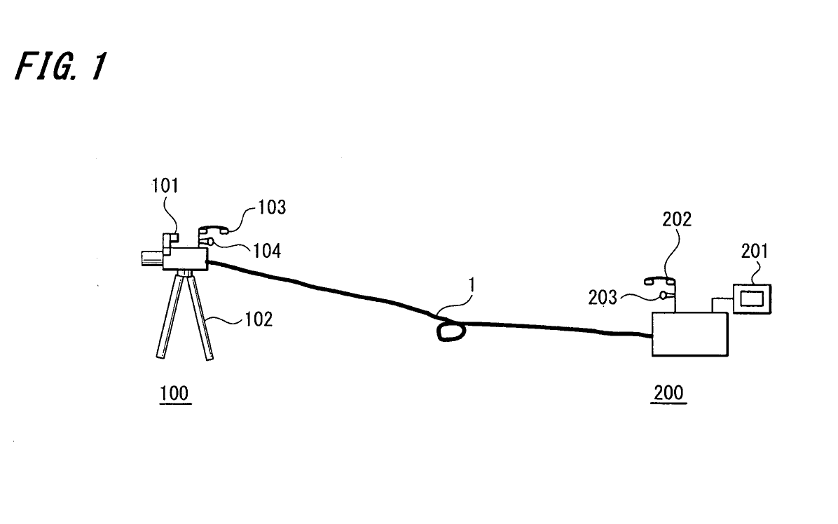

FIG. 1 is a schematic diagram showing an example of a connection between a video camera as an image-capture apparatus and a camera control unit (hereinafter, referred to as CCU) according to the present embodiment. The video camera 100 includes a viewfinder 101. The viewfinder 101 displays not only an image captured by the video camera 100 but also control information such as configuration information of the video camera 100 and status information thereof. The video camera 100 is attached with a tripod 102 and connects to the CCU 200 through a transmission cable 1. Information transmitted from the video camera 100 to the CCU 200 includes an image and a sound captured by the video camera 100, control information of the video camera 100, and a warning command signal as described later. In addition, information transmitted from the CCU 200 to the video camera 100 includes a return video signal and a control signal for controlling the video camera 100.

The video camera 100 is provided with an intercom (hereinafter, referred to as “incom”) for communicating with a user of the CCU 200. The video camera is designed so that a photographer of the vide camera 100 is able to communicate by voice with an operator of the CCU 200 using an incom headphone 103 and an income microphone 104. Likewise, the CCU 200 is also provided with an incom headphone 202 and an income microphone 203 to communicate with a photographer of the video camera 100. In addition, the transmission cable 1 for connecting the video camera 100 with the CCU 200 may be a TRIAX cable, an optical fiber cable, or the like.

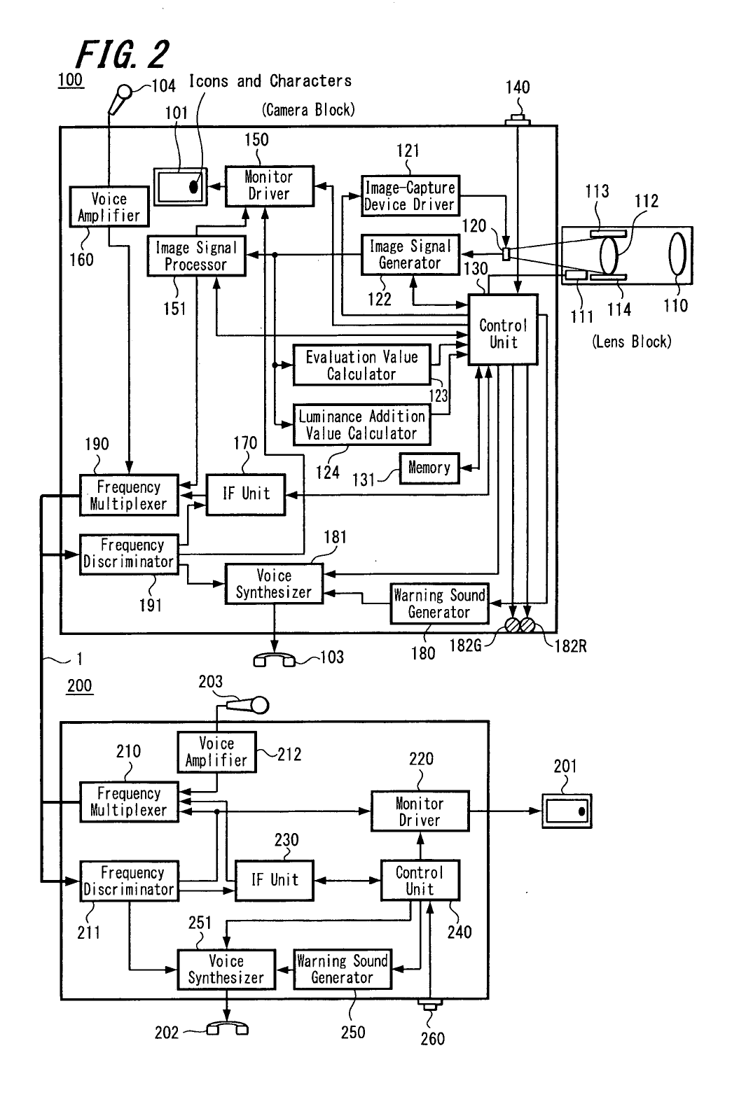

Next, referring now to a block diagram in FIG. 2, configuration examples of the video camera 100 and the CCU 200 will be described, respectively. A lens block of the video camera includes a lens group that has a focus lens 112 configured to focus a subject image incident on an image-capture lens 110 on an image-capture surface of the image-capture device, a position detector 113 configured to detect positions of each lens, a lens drive mechanism 114 configured to drive each lens, a lens driver 111 configured to control movement of the lens drive mechanism 114 and the like. Lenses such as a wobbling lens used to determine the directions of focal position other than the focus lens 112 and the image-capture lens 110 are omitted from the lens block shown in FIG. 2.

The focus lens 112 includes the position detector 113 configured to detect positions of the focus lens 112 or focus positions, the lens drive mechanism 114 configured to move the positions of the focus lens in the direction of an optical axis, and the lens driver 111 configured to move the lens drive mechanism. The focus position detected by the position detector 113 is temporarily stored in RAM (not shown). Likewise, a wobbling lens (not shown) includes a wobbling lens driving mechanism configured to move a position detector and lens position in the direction of an optical axis in order to perform appropriate wobbling. The lens block includes an aperture stop (not shown) configured to limit an amount of light that can pass through; and the aperture stop includes an aperture stop position detector configured to detect the aperture size of the aperture stop and an aperture stop drive mechanism configured to open and close the aperture stop.

The lens driver 111 is supplied with respective detected signals from the position detector 113 including: a signal to indicate focus positions, a signal to indicate an amount of wobbling, and a signal to indicate the aperture size of the aperture stop. The lens driver 111 including a lens CPU and a lens drive circuit is configured to move a focus (focal point) of the focus lens 112 according to instructions transmitted from the control unit 130. The lens driver 111 is connected with a user interface (not shown) configured to set modes of auto-focus or initiate the auto-focus operation, so that the lens driver 111 is supplied with operation signals according to operation of the user interface. The lens driver 111 includes a storage (not shown) having a ROM or EEPROM, on which information is stored, such as focal length data of the focus lens 112 and the wobbling lens, aperture ratio data, the name of manufacturer, and manufacturer's serial numbers.

The lens driver 111 generates lens drive signals based on the stored information, respective detected signals, and focus control signals or wobbling control signals described later supplied from the control unit 130. The lens driver 111 also supplies generated lens drive signals to the lens drive mechanism 114 to move the focus lens 112 to a desired focus position. The lens driver 111 supplies the generated lens drive signals to a wobbling lens drive mechanism to wobble the wobbling lens, so that the focus lens 112 may detect a direction of a focus position. The lens driver 111 further generates aperture stop drive signals to control the aperture size of the aperture stop.

In the video camera shown in FIG. 2, the subject image is formed on the image-capture device 120 via the focus lens 112. Then, the subject image is then photo-electrically converted into electric signals by the image-capture device 120 and output to the image signal generator 122. The image-capture device 120 may include a CCD (Charge Coupled Devices), CMOS (Complementary Metal Oxide Semiconductor), and the like. The image-capture device driver 121 is one example of the image-capture device drive circuit that supplies drive signals to the image-capture device 120 for photo-electronically converting the subject image formed on the image-capture device 120 into signals. The drive signals are supplied based on a vertical direction synchronization signal, a horizontal direction synchronization signal, and a clock signal generated from a clock signal generator that all used for a standard operation for each unit of the video camera.

In image signal generator 122, electric signals output from the image-capture device 120 are subject to appropriate signal processing, and image signals complied with a predetermined standard are generated. The image signals are transmitted to a circuit group (image signal processor 151), and are also input to the evaluation value calculator 123. The evaluation value calculator 123 is configured to filter high frequency components of image signals in a specific region provided within a captured image frame, and calculates the evaluation values relative to the image contrast. In imaging a typical subject, the evaluation values generally increases as a subject image approximates in-focus state, and the evaluation value is relative maximum when the subject image is in-focus. The evaluation value is updated once for one field of image signals. Auto-focus operation using evaluation values is well-known technology in the art, one example of which is described in detail in Japanese Unexamined Patent Application Publication No. H10-213736 previously disclosed by the applicant of the present invention.

The aforementioned processing is performed for each of three primary colors R (Red), G (Green), and B (Blue). For example, the camera block includes a color separating prism (not shown) located upstream of the image-capture device 120. The color separating prism separates light incident from the lens block into the three primary colors R, G, and B, and supplies the R component light to R component image-capture device, the G component light to G component light to G component image-capture device, and the B component light to B component image-capture device, respectively. In FIG. 2, the three R, G, and B component image-capture devices are represented as an image-capture device 120.

The subject images for each color formed on the image-capture device 120 are subject to predetermined processing before the subject images are photo-electrically converted into signals by the image-capture device 120 and output to the image signal generator 122. The image signal generator 122, for example, includes a preamplifier (not shown) and an A/D (Analog/Digital) converter. The level of the electric signals input to the image signal generator 122 is amplified by the preamplifier, and correlated double sampling is performed on the signals to eliminate a reset noise, and the A/D converter converts analog signals into digital image signals. Further, the image signal generator 122 is configured to perform gain control, black level stabilizer, or dynamic range control, and the like of the supplied image signals for each color, and supply the image signals thus obtained to the image signal processor 151, the evaluation value calculator 123, and the luminance addition value calculator 124.

The image signal processor 151 performs various signal processing of the image signals supplied from the image signal generator 122, and generates output image signals. For example, the image signal processor 151 performs knee correction to compress image signals at or above a certain level, gamma correction to set a correct level for image signals according to a configured gamma curve, and white clip processing or black clip processing to limit image signal levels to a predetermined range. The image signal processor 151 also performs edge enhancement processing or linear matrix processing, encode processing, or the like to generate output image signals in a desired format.

The evaluation value calculator 123 filters the high frequency components using image signals in a specific region provided within the captured image frame of the image signals for each color supplied from the image signal generator 122 to calculate evaluation values ID corresponding to the image contrast. The calculated evaluation values ID is stored in RAM through the control unit 130.

The image signal generator 122 having such as a preamplifier and A/D converter, the image signal processor 151, the evaluation value calculator 123, and the like, perform respective processing using the vertical direction synchronization signal VD, the horizontal direction synchronization signal HD, and the clock signal CLK synchronized with the image signals supplied from the previous stage. The vertical direction synchronization signal VD, the horizontal direction synchronization signal HD, and the clock signal CLK may alternatively be obtained from the clock signal generator.

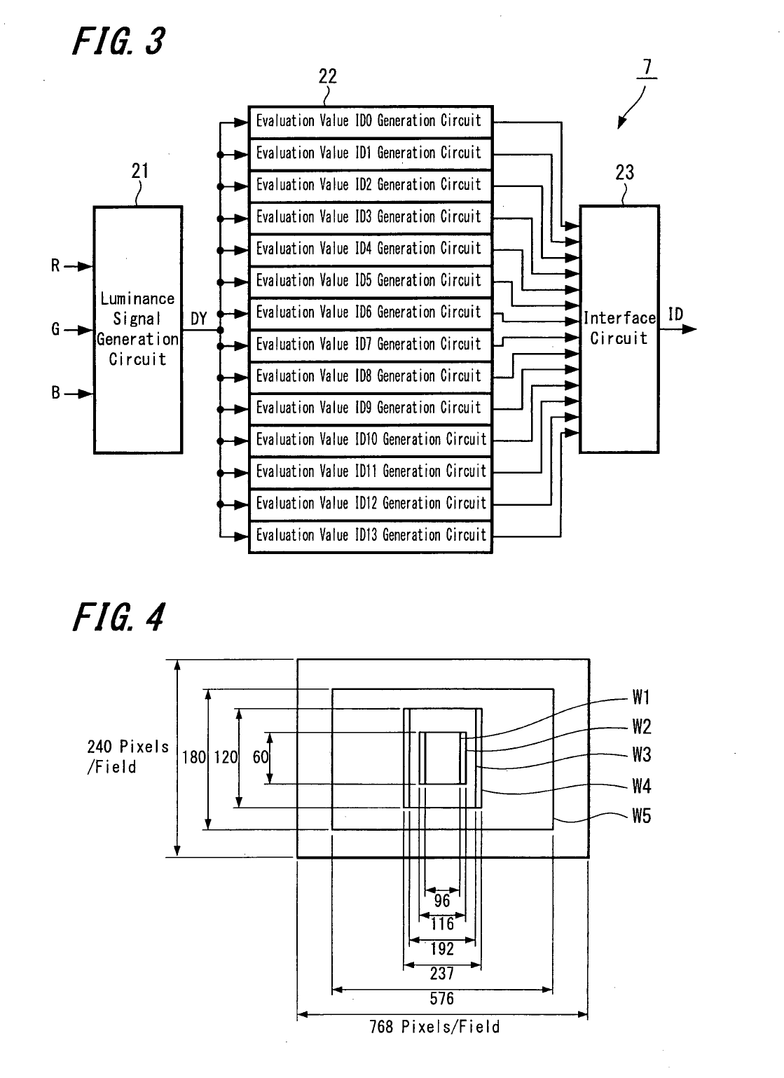

The evaluation value calculator 123 is described more in detail below. FIG. 3 illustrates a configuration of the evaluation value calculator 123. The evaluation value calculator 123 includes a luminance signal generation circuit 21 configured to generate a luminance signal DY based on image signals for each color, the evaluation value generation circuit 22 to generate 14 types of evaluation values ID0 to ID13 as described below, and an interface circuit 23. The interface circuit 23 is configured to communicate with the control unit 130 and supply the generated evaluation values according to requests from the control unit 130.

The image signal generator 21 performs the following operation: DY=0.30R+0.59G+0.11G using the image signals R, G, B supplied from the image signal generator 122 and generate a luminance signal DY. The luminance signal DY is generated in this manner, because it is sufficient to simply detect changes in the level of contrast and determine whether contrast is high or low in order to determine whether a subject image is in-focus or out of focus.

The evaluation value generator 22 generates the evaluation values ID0 to ID13. The evaluation values ID0 to ID13 are obtained by summing the frequency components of image signals in a specific region (hereinafter called “evaluation frame”) provided within the captured image frame, and provide values corresponding to the blurring of the image.

### Evaluation values ID0: Evaluation value name “IIR1_W1_HPeak”

### Evaluation values ID1: Evaluation value name “IIR1_W2_HPeak”

### Evaluation values ID2: Evaluation value name “IIR1_W2_HPeak”

### Evaluation values ID3: Evaluation value name “IIR4_W3_HPeak”

### Evaluation values ID4: Evaluation value name “IIR0_W1_VIntg”

### Evaluation values ID5: Evaluation value name “IIR3_W1_VIntg”

### Evaluation values ID6: Evaluation value name “IIR1_W1_HIntg”

### Evaluation values ID7: Evaluation value name “Y_W1_HIntg”

### Evaluation values ID8: Evaluation value name “Y_W1_Satul”

### Evaluation values ID9: Evaluation value name “IIR1_W3_HPeak”

### Evaluation values ID10: Evaluation value name “IIR1_W4_HPeak”

### Evaluation values ID11: Evaluation value name “IIR1_W5_HPeak”

### Evaluation values ID12: Evaluation value name “Y_W3_HIntg”

### Evaluation values ID13 Evaluation value name “Y_W3_HIntg”

Evaluation value names indicating the attributes (data used_evaluation frame size_evaluation value calculation method) are provided with the evaluation values ID0 to ID13.

The data used in the evaluation value name include two types, namely, “IIR” and “Y”. The “IIR” implies the data involving high-frequency components acquired from the luminance signal DY via HPF (high-pass filter); whereas the “Y” implies the data involving mere frequency components obtained from the HPF without using the HPF.

When using a HPF, an IIR type (infinite impulse response type) HPF is used. Evaluation values are divided into IIR0, IIR1, IIR3, and IIR4 according to the type of HPF; these represent HPFs having different respective cutoff frequencies. Thus, by setting HPFs having different cutoff frequencies, for example, by using a HPF having a high cutoff frequency in the vicinity of in-focus position, changes in the evaluation value can be increased compared with the case of using a HPF with a low cutoff frequency. Further, when the captured image is largely out of focus, changes in the evaluation value can be increased using a HPF with a low cutoff frequency compared with the case of using a HPF with a high cutoff frequency. In this manner, HPFs having different cutoff frequencies may be set according to the focusing state during auto-focus operation in order to select the optimal evaluation value.

The evaluation frame size implies the size of the image region used in evaluation value generation. As shown in FIG. 4, five types of evaluation frame sizes, W1 to W5, may for example be provided; the center of each evaluation frame corresponds to the center of the captured image. In FIG. 4, the evaluation frame sizes W1 to W5 when the image size for one field is 768 pixels×240 pixels are illustrated.

Evaluation frame size W1: 116 pixels×60 pixels

Evaluation frame size W2: 96 pixels×60 pixels

Evaluation frame size W3: 232 pixels×120 pixels

Evaluation frame size W4: 192 pixels×120 pixels

Evaluation frame size W5: 576 pixels×180 pixels

Thus, different evaluation values can be generated corresponding to the frame sizes by setting one of the plurality of frame sizes. Hence, an appropriate evaluation value can be obtained by setting one of the evaluation values ID0 to ID13, regardless of the size of the target subject.

Evaluation value calculation methods include the HPeak, HIntg, VIntg, and Satul methods. The HPeak system implies calculating horizontal evaluation values by the peak system; the HIntg system includes calculating horizontal evaluation values by the whole integration system; the VIntg system involves calculating vertical-direction evaluation values by the integration system and the Satul system includes the number of saturated luminance.

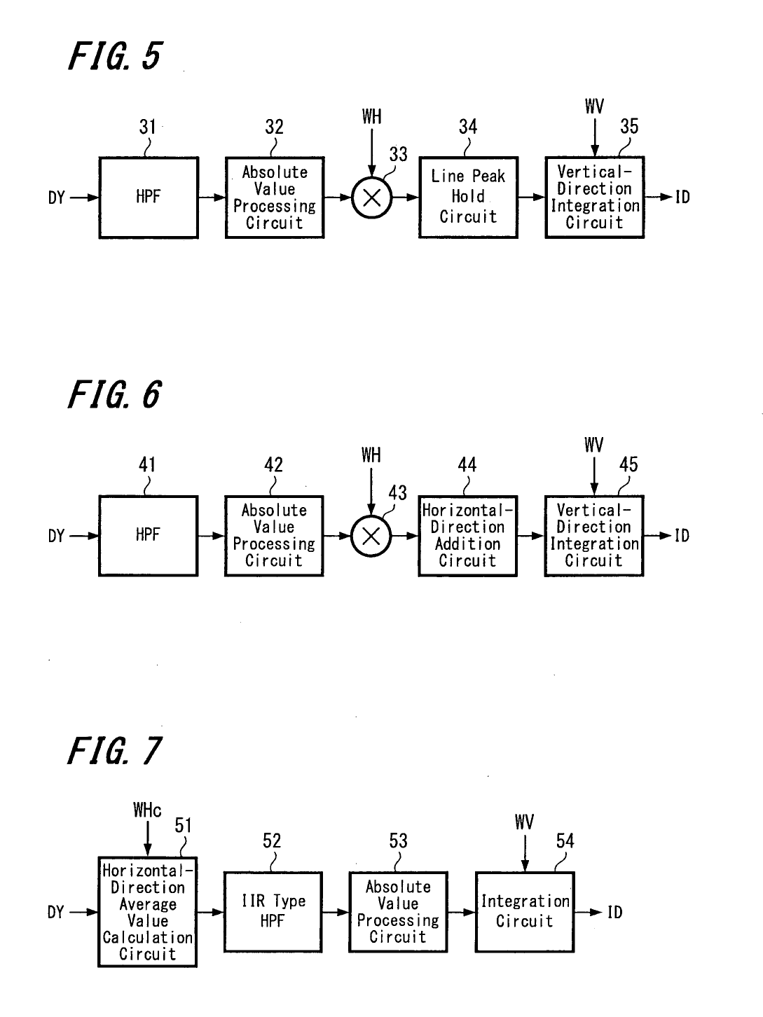

The HPeak method is an evaluation value calculation method in which a HPF is used to determine high-frequency components from horizontal-direction image signals, and is used to compute the evaluation values ID0, ID1, ID2, ID3, ID9, ID10, and ID11. FIG. 5 shows the configuration of a horizontal-direction evaluation value calculation filter used for the HPeak method. The horizontal-direction evaluation value calculation filter includes a HPF 31 that filters only high-frequency components from the luminance signals DY of the luminance signal generation circuit 21; an absolute value processing circuit 32 that selects the absolute values of the high-frequency components; and a multiplication circuit 33 that multiplies the absolute values of the high-frequency components by the horizontal-direction frame control signals WH. The filter further includes a line peak hold circuit 34 that holds one peak value per line; and a vertical-direction integration circuit 35 that integrates the peak values for all the lines in the evaluation frame in the vertical direction.

The high-frequency components of the luminance signals DY are filtered by the HPF 31, and absolute values selected by the absolute value processing circuit 32. Subsequently, the horizontal-direction frame control signals WH are multiplied by the multiplication circuit 33 to obtain absolute values of high-frequency components within the evaluation frame. That is, if frame control signals WH the multiplication value of which is “0” outside the evaluation frame are supplied to the multiplication circuit 33, then only the absolute values of horizontal-direction high-frequency components within the evaluation frame are supplied to the line peak hold circuit 34. Here, the frame control signals WH in the vertical direction form a square wave; however, the frame control signals WH in the horizontal direction do not merely include characteristics of a mere square wave but include characteristics of a triangular wave, so that the multiplied value of the frame control signals WH is reduced in the periphery of the frame (both ends). Thus, as the subject image within the frame approximates in-focus state, it is possible to reduce effects caused by the subject image interfering the external edges around the periphery of the frame (high luminance edges in the evaluation frame, including noise, drastic change, or the like of the evaluation values) or variability in the evaluation values caused by movement of the subject can be decreased. The line peak hold circuit 34 holds the peak values for each line. The vertical-direction integration circuit 35 adds peak values held for each line within the evaluation frame in the vertical direction, based on vertical-direction frame control signals WV, thereby obtaining the evaluation value. This method is called the HPeak method, because horizontal-direction (H) peaks are held temporarily.

The HIntg method is defined as a total-integration type horizontal-direction evaluation value calculation method. FIG. 6 illustrates a configuration of a total-integration type horizontal-direction evaluation value calculation filter. This total-integration horizontal-direction evaluation value calculation filter is used in figuring out the evaluation values ID6, ID7, ID12, and ID13. Compared with the HPeak method horizontal-direction evaluation frame control signals WH calculation filter of FIG. 5, the HIntg method filter is configured to include a HPF 41, an absolute value processing circuit 42, and a multiplication circuit 43 the three units of which are similar to those from 31 to 33 in FIG. 5. However, this method differs in that, in the horizontal-direction addition circuit 44 the absolute values of horizontal-direction high-frequency components in the evaluation frame are all added, and then, in the vertical-direction integration circuit 45, the addition results for all lines in the vertical direction in the evaluation frame are integrated in the vertical direction. Moreover, there is a difference between the HPeak method and the HIntg method in the following point; whereas in the HPeak method one peak value is determined per line, and the obtained peak values are added in the vertical direction, in the HIntg method the absolute values of horizontal-direction high-frequency components for each line are all added, and then the obtained high-frequency components are added in the vertical direction.

The HIntg method is divided into IIR1 and Y. The IIR1 employs high-frequency components as the data, whereas the Y employs original luminance signals DY. Luminance addition values are obtained by a luminance addition value calculation filter circuit, resulting by removing the HPF 41 from the total-integration type horizontal-direction evaluation value calculation filter of FIG. 6.

The VIntg method is a total-integration type vertical-direction evaluation value calculation method, used for obtaining the evaluation values ID4 and ID5. In both the HPeak method and the HIntg method, values are added in the horizontal direction to generate evaluation values; however, in the VIntg method, high-frequency components are added in the vertical direction to generate the evaluation values. For example, in a case of an image the upper half of which is white while the lower half is black, such as an image with a horizon or other scenes, so that there are only high-frequency components in the vertical direction but are no high-frequency components in the horizontal direction, the HPeak method horizontal-direction evaluation value does not function effectively. Hence the evaluation value in VIntg method is used in order that AF functions effectively for such scenes.

FIG. 7 illustrates a configuration of a vertical-direction evaluation value calculation filter that calculates vertical-direction evaluation values. The vertical-direction evaluation value calculation filter has a horizontal-direction average value calculation filter 51, an IIR-type HPF 52, an absolute value processing circuit 53, and an integration circuit 54. The horizontal-direction average value calculation filter 51 selects luminance signals of pixels (e.g., 64 pixels) in the center portion of the evaluation frame in the horizontal direction from the luminance signals DY for each line, based on a frame control signals WHc, computes the average value (or the total value) using the selected luminance signals. The horizontal-direction average value calculation filter 51 then outputs one result for one horizontal period. Here, the 64 pixels of the center portion are specified to be used to remove noise in the evaluation frame peripheral portion. In the vertical-direction evaluation value calculation filter, the luminance signals per 64 pixels are sequentially accumulated, and finally one average value of the luminance signals per 64 pixels is output, so that the vertical-direction evaluation value calculation filter may not need include a line memory, frame memory, or other memory device, resulting in a simple configuration. Subsequently, this horizontal-direction average value is synchronized with the line frequency and high-frequency components are filtered by the HPF 52, and the absolute value processing circuit 53 is used to convert the filtered high-frequency components into the absolute values of the high-frequency components. Further, the integration circuit 54 integrates over all lines within the evaluation frame in the vertical direction based on the vertical-direction frame control signal WV.

The Satul method is a calculation method in which the number of luminance signals DY that are saturated; that is, a luminance level equal to or above a predetermined level, within an evaluation frame is determined, and the outcome is used in calculating the evaluation values ID8. In calculating the evaluation values ID8, the luminance level of the luminance signal DY is compared with a threshold α, and the number of pixels for which the luminance level of the luminance signal DY is equal to or above the threshold α in the evaluation frame is counted for each field, and the outcome is determined as the evaluation values ID8.

The configuration of the video camera is described by referring back to FIG. 2. The luminance addition value calculator 124 is a circuit configured to integrate the luminance of image signals in a specific region (central portion) obtained by the image-capture device 120 and generate the luminance addition values. The luminance addition value calculator 124 adds the luminance signals in a specific region obtained from image signals for each color input from the image signal generator 122, and the added result is output to the control unit 130 as the luminance addition values.

The control unit 130, for example, includes a CPU (Central Processing Unit), RAM (Random Access Memory), and ROM (Read Only Memory) not shown, and retrieves computer programs stored in the ROM onto the RAM to run the programs, and hence a predetermined control and processing such as auto-focus operation are performed. The control unit 130 receives evaluation values calculated by an evaluation value calculator 123 once for one field, and searches the peak of the evaluation values. The auto-focus operation is performed using instructions as a trigger from a one-shot switch 140 that directs activation of the auto-focus operation. Furthermore, the control unit 130 generates various kinds of command signals according to the result of determining the certainty whether the subject is in focus. The command signals include warning-command signals for specifying the kinds of warning sounds and display command signals for displaying on the viewfinder 101 characters, icons, and so on depending on the certainty whether the subject is in focus. The details of the process for determining the certainty whether the subject is in focus will be described later.

The control unit 130 and the lens driver 111 of the lens block are configured such that the control unit 130 and the lens driver 111 may communicate with each other using predetermined formats and protocols, and collaborate to control the auto-focus operation. The lens driver 111 supplies various information such as the focus position or the value indicating the aperture stop size to control unit 130. The lens driver 111 generates lens drive signals based on focus control signals or wobbling control signals supplied from the control unit 130 to perform drive processing on the focus lens 112 and wobbling lens. The control unit 130 generates and supplies the focus control signal for controlling to drive the focus lens 112 or the wobbling control signals for controlling to drive the wobbling lens to the lens driver 111, based on the evaluation values ID calculated by the evaluation value calculator 123 and the various information retrieved from the driver 111.

Each of the lens driver 111 and the control unit 130 incorporates a microcomputer and a memory to perform the auto-focus operation by retrieving to run a program stored in the non-volatile memory.

A memory 131 is a storage unit into which data are written and from which data are read out by the control unit 130. The storage unit is configured to store information such as the focus position of the focus lens 112 and the evaluation value calculated at the evaluation value calculator 123.

Indicators 182G, 182R are one example of display units; each of which includes a light emitting diode (LED; Light Emitting Diode (green, red) respectively. The indicator 182G or 182R lights up based on the outcome of reliability of the subject image being in-focus assessed by the control unit 130. It is apparent that neither type nor color used for an indicator may be limited to those described above as the example.

An interface 170 (hereinafter called “IF unit”) is one example of a signal output unit. The IF unit outputs various command signals output from the control unit 130 according to the result of assessing the reliability of the subject being in focus or an evaluation value and a luminance addition value to be provided as criteria for assessing the reliability of the subject being in focus, to a frequency multiplexer 190. The IF unit 170 supplies respective units with control signals or the like input from a frequency discriminator 191 as described later. Thus, the movement of the video camera 100 may be controlled under control of the camera control unit 200.

A monitor driver 150 is configured to generate an image signal output from a image signal processor 151 and drive signals for displaying characters, icons, or the like directed by the control unit 130 on the viewfinder 101. The drive signal is supplied to the viewfinder 101 based on respective synchronization signals and the clock signal included in the image signals. In the case where display command signals are supplied from the control unit 130 to the viewfinder 101, image signals input from the image signal processor 151 are superimposed with characters, icons, or the like in response to a display command signal and then supplied to the viewfinder 101, respectively.

The frequency multiplexer 190 is installed as a transmitting unit and then multiplexes a voice signal input from the voice amplifier 160, an image signal input from the image signal processor 151, various kinds of command signals input from the IF unit 170, and control-information signals input from the respective units, followed by transmitting the multiplexed signal to CCU 200 through the transmission cable 1. The frequency discriminator 191 is installed as a receiving unit and then discriminates a frequency-multiplexed signal transmitted from the CCU 200 through the transmission cable 1, followed by extracting an incom voice signal, a return video signal, a control signal, or the like. The extracted incom voice signal is transmitted to the voice synthesizer 181, while the return video signal is transmitted to the monitor driver 150.

The voice amplifier 160 amplifies an output voice signal after voice-electric conversion over an incom microphone 104 and the amplified voice signal is then supplied to the frequency multiplexer 190 as described later. A warning sound generator 180 is designed so that various kinds of warning sounds may be generated using a plurality of frequency bands. When a warning-command signal is supplied from the control unit 130 to the warning sound generator 180, a warning sound is selected corresponding to the input warning-command signal. The selected warning sound is transmitted as a warning-sound signal to the voice synthesizer 181. In the present embodiment, a plurality of warning sounds being defined according to frequency bands is exemplified. However, another method may be employed to generate a plurality of warning sounds, such as one in which a plurality of warning sounds having different intervals of turning the sounds on and off. Furthermore, the warning sound may be a synthesized human voice.

The voice synthesizer 181 combines a warning-sound signal input from the warning sound generator 180 and an incom voice signal from the frequency discriminator 191.

Next, a configuration example of the CCU 200 will be described. A frequency discriminator 211 discriminates a frequency multiplexed signal transmitted from the video camera 100 through the transmission line 1 and then transmits each of the extracted signals to each unit of the CCU 200. In the case where the IF unit 230 receives the control information to be fed to the video camera 100 from the control unit 240, the IF unit 230 converts the control information to a serial signal and then inputs the serial signal into a frequency multiplexer 210 as described later. In the case where the IF unit 230 receives a control-information signal or the like of the video camera 100 from a frequency discriminator 211, the IF unit 230 inputs each single into each unit of the video camera 100. The monitor driver 220 superimposes characters, icons, or the like in response to a command signal input from control unit 240 onto an image signal discriminated by the frequency discriminator 211 and then transmits the superimposed signal to an external monitor 201.

A voice synthesizer 251 combines a warning-sound signal input from the warning sound generator 250 with an incom voice signal extracted by the frequency discriminator 211 to generate a voice-synthesized signal.

The frequency multiplexer 210 multiplies a return video signal input from the frequency discriminator 211 with a control-information signal input from the control unit 240 to the video camera 100. In the case where a voice input with an operator is provided over the incom microphone 203, an incom voice amplified by the voice amplifier 212 is also multiplexed and then transmitted as a frequency multiplexed signal to the video camera 100 through the transmission cable 1.

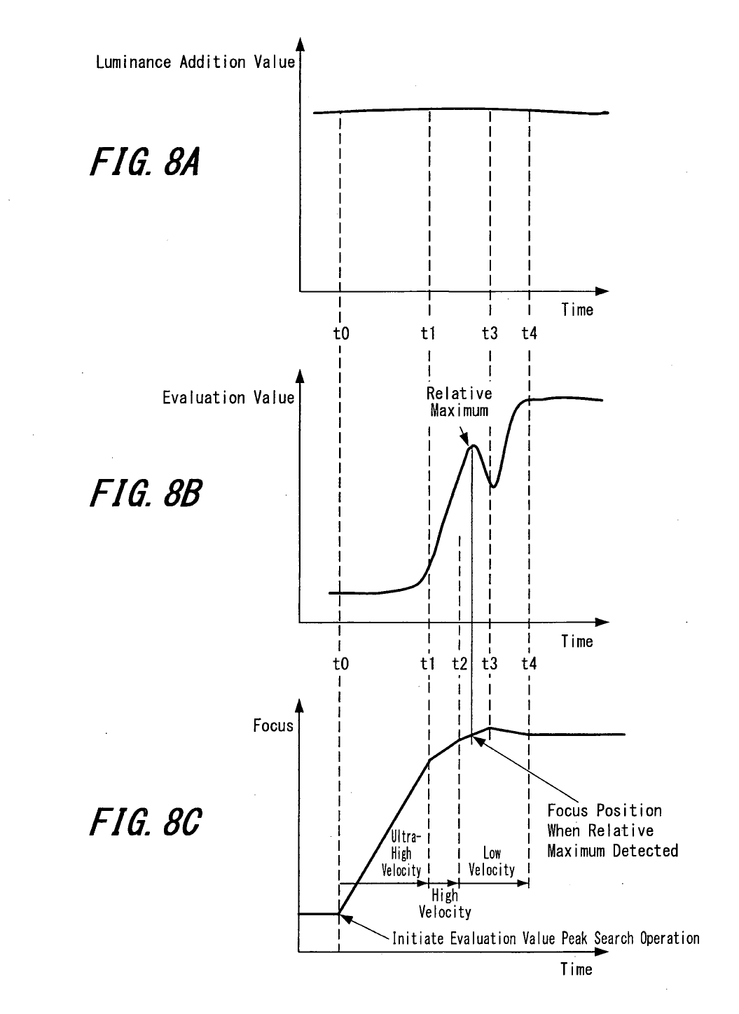

A method of determining reliability of whether a subject image is in-focus or out-of-focus is described as follows with reference to the following FIGS. 8 to 12.

FIGS. 8A, 8B and 8C respectively illustrate fluctuations of luminance addition values, evaluation values, and focus while the focus lens of the video camera searches the position corresponding to a point at which the peak of the evaluation values is detected. The vertical axes of the graphs 8A, 8B, and 8C respectively indicate the luminance addition values, the evaluation value, and movements of the focus lens, and the horizontal axes of three indicate time. The curves shown on the graphs are plotted once for one field of the image signals or a plurality of data obtained on an irregular base. FIG. 8C shows that focusing is performed at an ultrahigh velocity in the time interval between t0 to t1, at a high velocity in the time interval between t1 to t2, and at a low velocity in the time interval between t2 to t3, and between t3 to t4 of the evaluation value peak search operation.

In this embodiment, the velocity of focusing varies with the focus position and the evaluation value; however, the velocity of focusing is not limited to this method, and the velocity of focusing may be configured to remain constant regardless of distance.

FIG. 8A shows that the luminance addition values hardly change despite the movement of the focus lens when imaging the subject with almost no wobbling by the video camera in a typical static manner. This results from the fact that the luminous flux that reaches a video camera does not generally fluctuate so much with a change in the state of focus.

By contrast, the evaluation value may change according to change in focus status. FIG. 8C shows the outcome while moving the focus lens between a point representing the initial increase and a point representing the detection of the relative maximum (between t0 and t3). After detecting the relative maximum (t3) using hill-climbing and hill-descending evaluations, the focus lens reverses a focus direction and returns the lens to the position corresponding to the point at which the relative maximum has been detected (t3 to t4).

When the focus lens returns to the position corresponding to the point at which the relative maximum has been detected, the evaluation value obtained is generally larger than the relative maximum as shown in FIG. 8B. In particular, the evaluation values obtained while moving the focus lens are generally smaller than the values obtained when the focus lens returns to and stops at the position corresponding to the point at which the relative maximum has been detected, because a change in the contrast of the subject image is generally small while moving the focus lens. That is, an accurate contrast cannot be obtained, because the focus lens is still moving at the position corresponding to the point at which the relative maximum is detected. Accordingly, the evaluation value obtained when the focus lens returns to and stops at the position corresponding to the point at which the relative maximum has been detected is generally smaller than the evaluation value obtained while the focus lens is passing the focus position at which the relative maximum is detected.

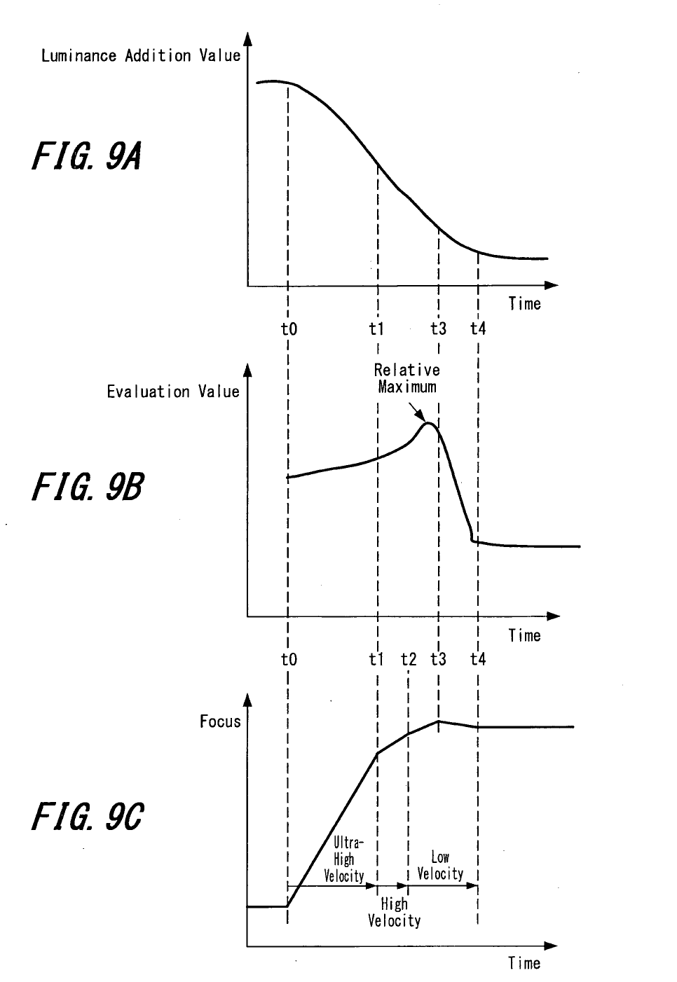

FIGS. 9A, 9B, and 9C respectively illustrate fluctuations of luminance addition values, evaluation values, and focus while the focus lens of the video camera searches the position corresponding to the peak of the evaluation values at which inaccurate focus may be determined. FIGS. 9A and 9B represent behaviors of the luminance addition values and the evaluation value when capturing an image with wobbling of the subject or wobbling of the video camera. FIG. 9B shows that the evaluation value is small while the subject image is out-of-focus although the focus lens returns to the position corresponding to the point at which the relative maximum has been detected. This results from generation of the inappropriate relative maximum obtained due to a change in the evaluation values while the subject or the video camera wobbles. In addition, the luminance addition values drastically change while the subject or the video camera wobbles as shown in FIG. 9A.

As descried above, whether a subject image is in-focus or out-of-focus at the focus position calculated by auto-focus unit is determined with a high reliability by examining the histories of the evaluation values and the luminance addition values.

Here, conditions used in criteria for determining whether a subject image is in-focus or out-of-focus are described below. The present embodiments employ two conditions A and B in the criteria. The condition A is used to determine whether or not auto-focus operation terminates normally, using the history of the evaluation values.

Condition A

In the condition A, if the relative maximum of evaluation values is defined as ea and the evaluation value obtained when the focus lens returns to and stops at the position corresponding to the point at which the relative maximum has been detected is defined as eb, a value obtained by dividing the evaluation value eb by the relative maximum ea is larger than the predetermined threshold. The condition A is represented by the following equation 1.

α<eb/ea 1

where α represents a constant.

The aforementioned α is defined based on the results obtained by experiments or tests conducted.

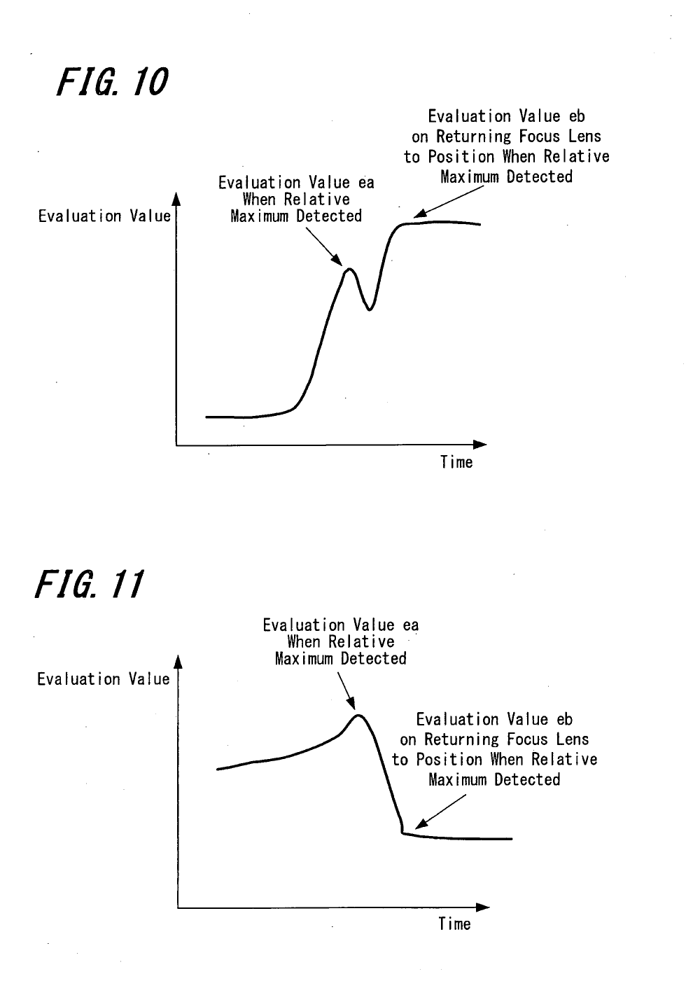

For example, when the value obtained from dividing the evaluation value eb by the relative maximum ea is larger than the predetermined threshold (equation 1 is satisfied) as shown in FIG. 10 (as in FIG. 8B), the subject image is determined to be in-focus state.

By contrast, when the value obtained from dividing the evaluation value eb by the relative maximum ea is smaller than the predetermined threshold, which is represented by the following equation α≧eb/ea as shown in FIG. 11 (as in FIG. 9B), the subject image is determined to be out-of-focus, because the equation 1 is not satisfied.

Next, the condition B is described below. The condition B includes a luminance condition in addition to the above condition A in order to more rigorously determine whether a subject image is in-focus or out-of-focus; that is, the condition B implies the more rigorous version of the condition A. According to the condition B, when luminance change is detected, the control unit 130 determines that wobbling may have occurred while detecting the relative maximum and hence the subject image is out-of-focus state, unless the following equations 1 and 2 are both satisfied simultaneously.

Condition B

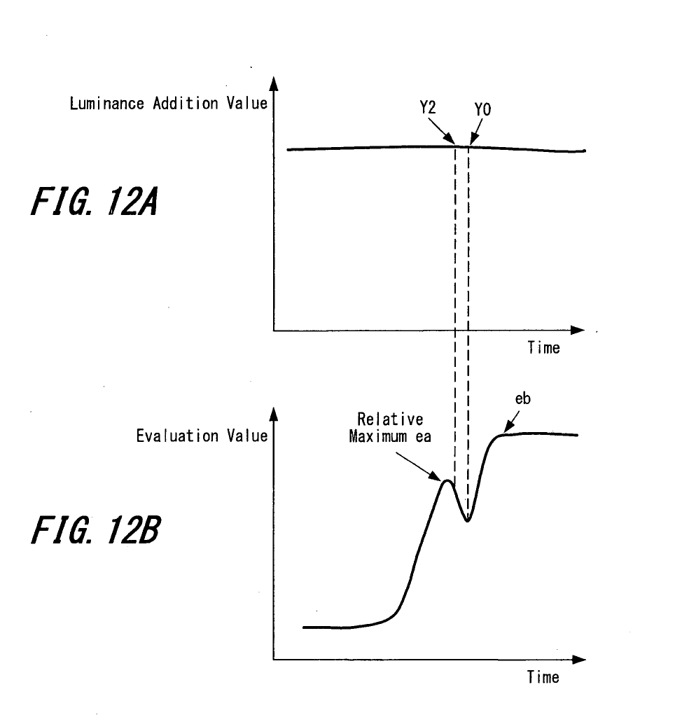

In the condition B, if the relative maximum of evaluation values is defined as ea and the evaluation value obtained when the focus lens returns to and stops at the position corresponding to the point at which the relative maximum has been detected is defined as eb, the value obtained by dividing the evaluation value eb by the relative maximum ea is larger than a first threshold. In addition, as shown in FIG. 12, when the luminance addition value obtained in the current field are determined as Y0 and the luminance addition value obtained two fields before the current field is determined as Y2, the value obtained by dividing the luminance addition value obtained in the current field by the luminance addition value obtained two fields before the current field is within the predetermined range. The condition B is represented by the following equations 1 and 2.

α<eb/ea 1

where α represents a constant.

γ1<Y2/Y0<γ2 2

where γ1 and γ1 represent a constant.

The condition B includes a condition (equation 2) to determine whether or not the values indicating the luminance change are within a predetermined range. If the condition B is not satisfied (e.g., see FIG. 9A), the auto-focus unit determines that the subject or the video camera has wobbled while focusing on the subject. Thus, obtaining the more accurate result of focus adjustment and improved reliability is secured by determining whether a subject image is in-focus or out-of-focus while eliminating wobbling of the subject or the video camera. In this embodiment, the luminance addition values used in the equation 2 are defined as the luminance values obtained two fields before the current field. However, the luminance addition values used in the equation 2 are not limited thereto; and any luminance addition values obtained predetermined fields before the current field may appropriately be used. The aforementioned values γ1 and γ2 are appropriately determined based on results obtained from experiments or tests conducted.

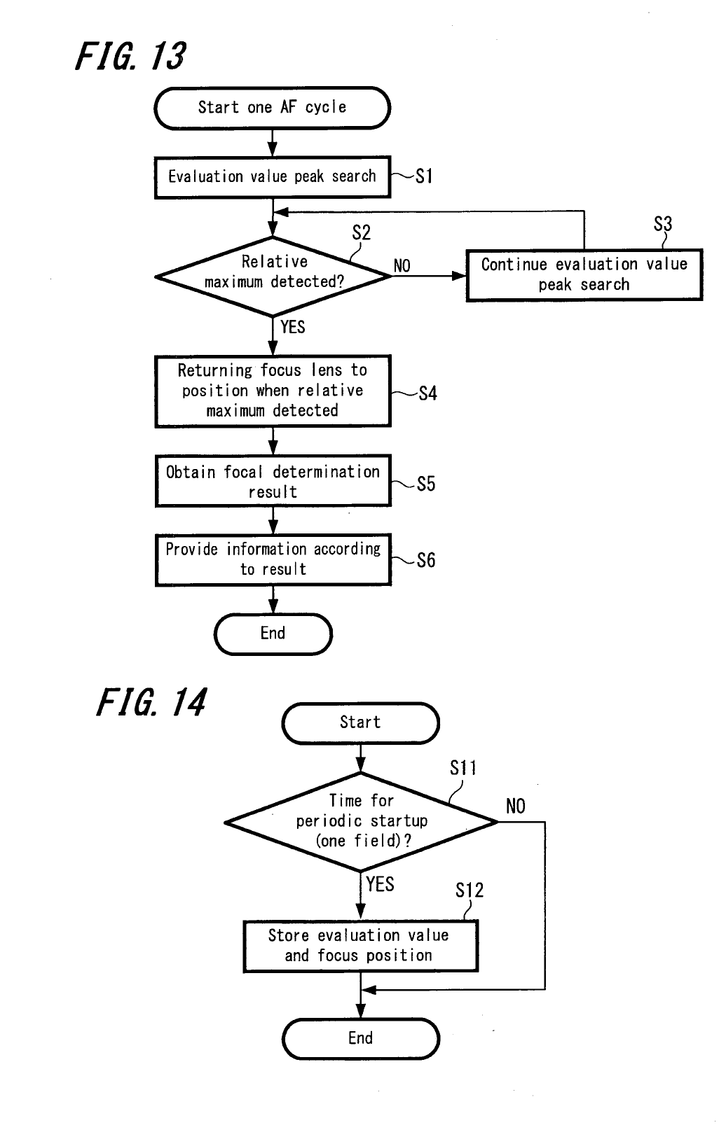

Next, auto-focus processing using the video camera according to the present embodiment will be described by referring to the flowchart shown in FIG. 13. In the auto-focus processing according to the present embodiment, the control unit 130 searches the peak of the evaluation values. If the relative maximum is detected, the evaluation value is computed when the focus lens returns to the focus position corresponding to the point at which the peak of the evaluation value has been detected. The control unit 130 analyzes the history of the evaluation values. That is, the control unit 130 analyzes a relation between evaluation values at the relative maximum and evaluation values when the focus lens returns to the focus position corresponding to the point at which the peak of the evaluation value has been detected, assesses reliability of the subject image being in-focus, and provides the outcome of reliability determination to a user.

In FIG. 13, the control unit 130 (see FIG. 2) of the video camera initiates one cycle of the auto-focus operation using some kind of triggers, such as predetermined timing or operation signals generated by a switch 140, and then searches the peak of the evaluation values output from the evaluation value calculator 123 (step S1).

The control unit 130 periodically stores evaluation values and focus positions in memory 131 as background processing, and operates to search the peak of evaluation values based on the stored information. As shown in the flowchart of FIG. 14, the control unit 130 determines whether or not the current time matches a periodic startup time, based on a synchronization signal contained in the image signals, or on clock signals input from a clock signal generator (not shown) (step S11). One example of the periodic startup time is defined as one field according to the present embodiments. If the control unit 130 determines that the current time matches one of the startup time, the control unit 130 initiates AF1 cycle operation, and stores the evaluation values calculated by the evaluation value calculator 123 and the focus positions transmitted from the position detector 113 in the memory 131 (step S12). When the control unit 130 determines that the current time does not match one of the periodic startup time, the control unit 130 terminates the determination processing at step S12.

The control unit 130 retrieves evaluation values and focus positions stored in the memory 131, and sets directions of movements of the focus lens 112 based on the retrieved evaluation value and focus positions.

The control unit 130 then determines whether or not the relative maximum has been detected (step S2) as shown in the flowchart of FIG. 13. When the control unit 130 has yet to detect the relative maximum, the control unit 130 continues to search the peak of the evaluation values until the relative maximum is detected (step S3).

In the determination processing at step S2, when the relative maximum is detected, the control unit 130 controls the lens driver 111 to return the focus lens to the position corresponding to the point at which the relative maximum has been detected (step S4).

The control unit 130 analyzes the history of the evaluation values. That is, the control unit 130 analyzes a relation between evaluation values at the relative maximum and evaluation values at the current position of the focus lens, and determines whether a subject image is in-focus or out-of-focus using the aforementioned conditions A and B (step S5).

The control unit 130 provides information based on the outcome as to determining whether a subject image is in-focus or out-of-focus at the aforementioned step S5 (step S6).

Moreover, it is possible to provide a plurality of results of determining whether the subject image is in-focus or out-of-focus using a condition C of relatively less rigorous equation 3, which includes a plurality of thresholds on ratios of the evaluation values, in addition to the equation 1. Accordingly, it is possible to assess reliability in more specific determination as to whether the subject image is in-focus or out-of-focus, and to provide detailed information on the focal determination to a user.

Condition C

If the relative maximum of evaluation values is defined as ea and the evaluation value obtained when the focus lens returns to and stops at the position corresponding to the point at which the local maximum has been detected is defined as eb, the condition is represented by the following equations:

α<eb/ea 1

β<eb/ea 2

where α and β represent constants (α>β)

In the present embodiment, the screen of the viewfinder 101 is designed to display any character or an icon corresponding to the above determination. In addition, the result of the determination may be also displayed on the indicator 11G or 11R (see FIG. 2). For example, in the case where the history of evaluation values satisfies condition A (or condition B), the indicator 11G emits green light for indicating the certainty that the subject is in focus. On the other hand, in the case where the history of evaluation values does not satisfy the predetermined condition, the indicator 11R emits red light for indicating a doubtfulness that the subject is in focus.

As described above, an embodiment of the present invention allows the viewfinder or the indicator to display information on the basis of the result of determining whether the subject is in focus. In addition, such a determination result allows the generation of various kinds of command signals from such a determination result to transmit these signals to the CCU. Furthermore, the CCU is allowed to display the determination result of whether the subject is in focus or give a voice message thereof. Details in transmission processing of command signals and so on between the video camera and the CCU will be described later.

Furthermore, the information to be transmitted between the video camera and the CCU is not only limited to one about the certainty whether the subject is in focus. For example, it has been known that the video camera gets old and rickety by variation with time, a signal-to-noise (SN) ratio of image signals input in the evaluation-value calculator deteriorates, and a percentage of being determined that the subject is in focus decreases. In the case where such a circumstance is recognized, the corresponding command signals may be generated and transmitted to the CCU.

The following description will describe what kind of actions are carried out in autofocus processing to cope with such a circumstance and then describe a method for detecting a trouble in the autofocus-mode movement when it is suspected.

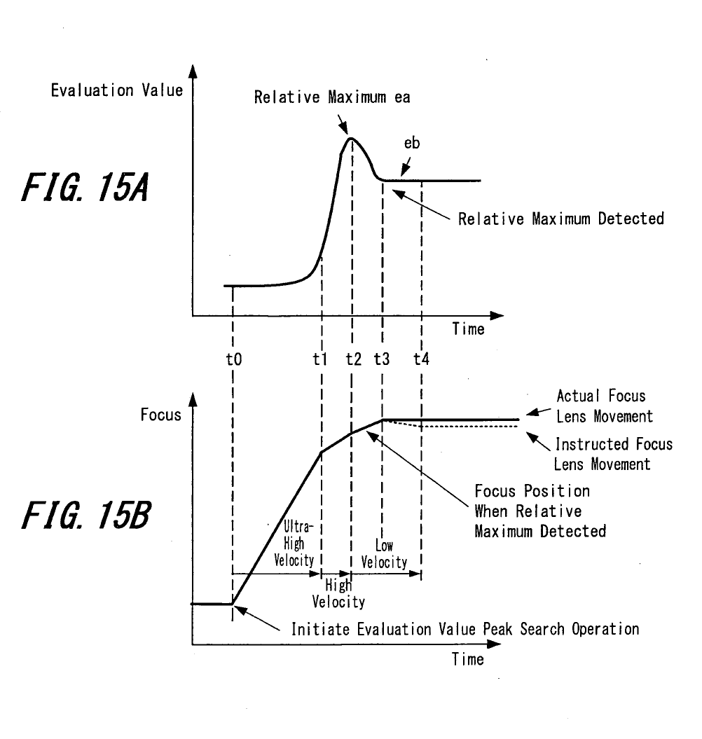

Malfunctions in auto-focus operation due to defects of the focus lens drive mechanism will be described by referring to FIGS. 15A, 15B. FIGS. 15A and 15B are graphs respectively illustrating fluctuations of evaluation values and movement of the focus lens when the focus lens drive mechanism includes some defects such as failure in the focus lens drive mechanism and performance degradation. The vertical axes of the graphs 15A, 15B respectively indicate the evaluation values and movement of the focus lens, and the horizontal axes of the two indicate time. The curves shown on the graphs are plotted once for one field of the image signals or a plurality of data obtained on an irregular base. FIG. 15B shows that focusing is performed at an ultrahigh velocity in the time interval between t0 to t1, at a high velocity in the time interval between t1 to t2, and at a low velocity in the time interval between t2 to t3, and between t3 to t4 of the evaluation peak search operation.

FIGS. 15A and 15B illustrate a case where the control unit 130 fails to return the focus lens to the position corresponding to the point at which the relative maximum has been detected, although the control unit 130 instructs the lens driver 112 to return the focus lens to the focus position corresponding to the point at which the relative maximum has been detected (t2) after having detected (t3) the relative maximum of the evaluation values. In FIG. 15B, a broken line represents the instructed movement of the focus lens directed by the control unit 130 after the relative maximum of the evaluation values has been detected, whereas a solid line represents the actual movement of the focus lens; thereby demonstrating that the movement of the focus lens does not follow the instructions provided by the control unit 130.

In such a case, a user may be informed by displaying warning signs indicating that failure has occurred in the focus lens mechanism. If the failure of this kind frequently or constantly occurs, the user normally notices the failure occurred in the auto-focus apparatus or video camera by the warning signs, and hence may prepare some kind of repair to amend the failure.

If, on the other hand, the failure occurs not so frequently, a user normally fails to notice the failure, and hence leaves the auto-focus apparatus unrepaired. As a result, the aforementioned failure may occur when the actual imaging is in progress.

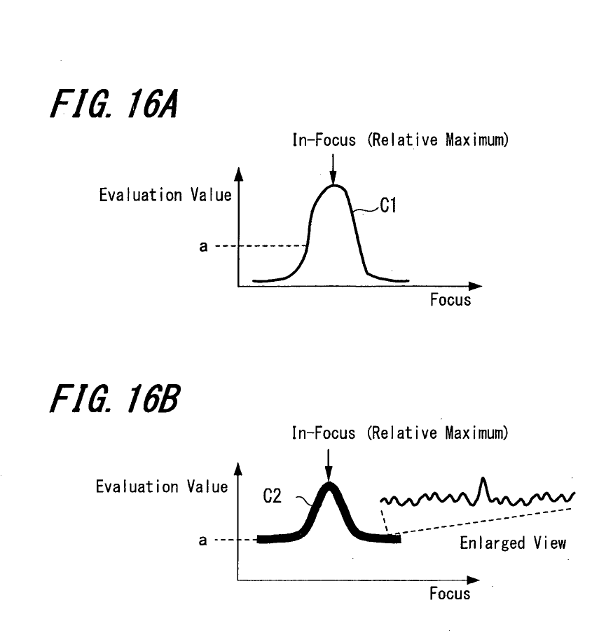

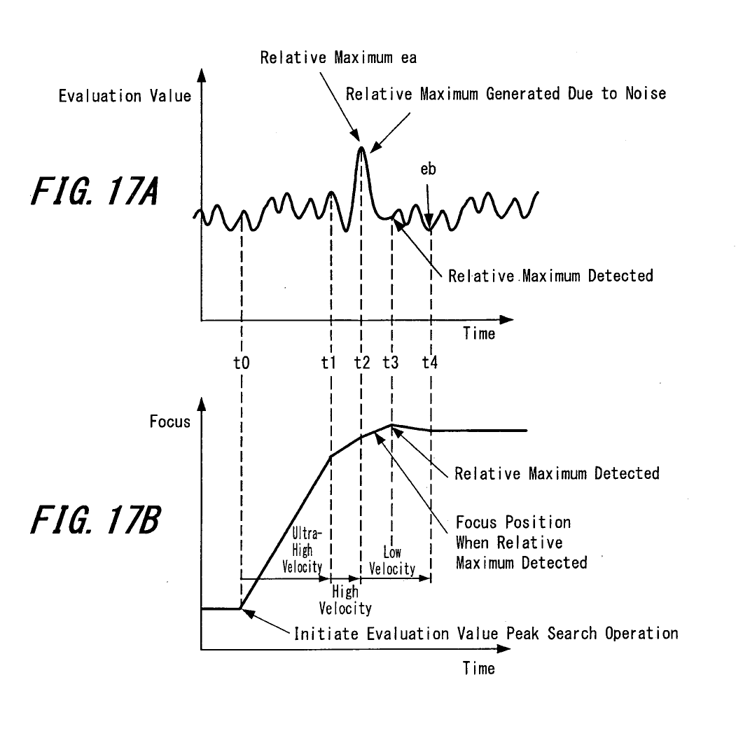

Malfunctions in auto-focus operation due to a decrease in the SNR (signal-to-noise ratio) of image signals will be described by referring to FIGS. 16A, 16B and FIGS. 17A and 17B. FIGS. 16A and 16B are graphs illustrating fluctuations of evaluation values due to presence or absence of a decrease in SNR. In respective FIGS. 16A, 16B, the horizontal axes indicate movement of the focus lens and the vertical axes indicate the evaluation values. FIGS. 17A and 17B are graphs respectively illustrating fluctuations of evaluation values and movement of the focus lens when the SNR of image signals decreases. The vertical axes of the graphs 17A and 17B respectively indicate the evaluation values and movement of the focus lens, and the horizontal axes of the two indicate time.

In general, when the SNR of image signals decreases, magnitudes and fluctuation of the evaluation values generally increase at the focus lens position corresponding to the point at which the captured subject image is blurred. Referred to FIGS. 16A and 16B, the evaluation value curve C2 including a decrease in SNR shows that the evaluation value and the amount of fluctuation (noise) obtained both increase at the position away from the focus position (in-focus position) at which the relative maximum of the evaluation values is detected; that is, at this focus position, the subject image is blurred, as compared to the evaluation value curve C1 without a decrease in SNR. The evaluation values are obtained by filtering the contrast of the image signals (high frequency components), and hence high frequency components increase according to an increase in the noise.

FIGS. 17A and 17B show a case where due to a decrease in SNR of the image signals, the relative maximum is erroneously detected at the position away from the focus position (in-focus position) at which the relative maximum of the evaluation values has been detected while searching the peak of the evaluation values. In this case, although the focus lens is returned to the focus position at which the relative maximum of the evaluation values has been detected (t2), the returned position does not correspond to a position where a subject image is in-focus, and hence the evaluation value obtained after returning the focus lens to the focus position is smaller than the above relative maximum of the evaluation values. The relative maximum generated in this case is due to noise in the image signals. Such incorrect detection may result from various causes such as the deterioration of a signal amplifier.

If the SNR of the evaluation signals is large enough for a user to notice image degradation caused by the SNR while imaging a subject, the user may ask a mechanic to have the focus mechanism repaired. However, if the SNR is not large enough for a user to notice, the user normally fails to notice the failure, and hence leaves the operation of auto-focus with some failure, causes of which cannot be detected. Thus, the operation of the auto-focus may be adversely affected if image quality (SNR) deteriorates in this manner.

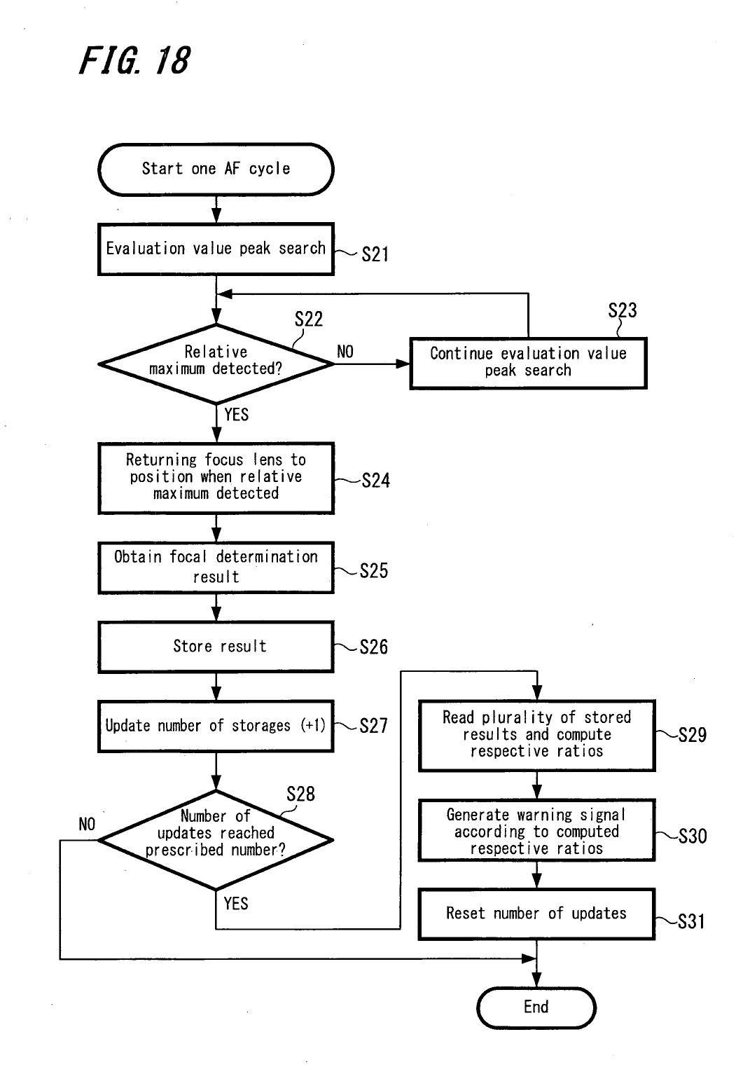

Next, auto-focus processing using the video camera will be described by referring to the flowchart shown in FIG. 18. In the auto-focus processing, the control unit 130 searches the peak of the evaluation values. If the relative maximum is detected, the evaluation value is computed when the focus lens returns to the focus position corresponding to the point at which the peak of the evaluation value has been detected. The control unit 130 analyzes the history of the evaluation values. That is, the control unit 130 analyzes a relation between evaluation values at the relative maximum and evaluation values when the focus lens returns to the focus position corresponding to the point at which the peak of the evaluation value has been detected, assesses reliability of the subject image being in-focus, and provides the outcome of reliability determination to a user.

In FIG. 18, the control unit 130 (see FIG. 2) of the video camera initiates one cycle of the auto-focus operation using some kind of triggers, such as predetermined timing or operation signals generated by a switch 140, and then searches the peak of the evaluation values output from the evaluation value calculator 123 (step S21).

The control unit 130 periodically stores evaluation values and focus positions as a background processing; that is, the control unit 130 stores the evaluation values and the focus positions in the background, and operates to search the peak of evaluation values based on the stored information. The process carried out here is the same as that shown in FIG. 14. Thus, the description will refer to FIG. 14. The control unit 130 determines whether or not the current time matches a periodic startup time, based on a synchronization signal contained in the image signals, or on clock signals input from a clock signal generator (not shown) (step S11). One example of the periodic startup time is defined as one field according to the present embodiments. If the control unit 130 determines that the current time matches one of the startup time, the control unit 130 initiates AF1 cycle operation, and stores the evaluation values calculated by the evaluation value calculator 123 and the focus positions transmitted from the position detector 113 in the memory 131 (step S12). When the control unit 130 determines that the current time does not match one of the periodic startup time, the control unit 130 terminates the determination processing at step S22.

Referring back to the flowchart of FIG. 18 for further description, the control unit 130 then determines whether or not the relative maximum has been detected (step S22). When the control unit 130 has yet to detect the relative maximum, the control unit 130 continues to search the peak of the evaluation values until the relative maximum is detected (step S23).

In the determination processing at step S22, when the relative maximum is detected, the control unit 130 controls the lens driver 111 to return the focus lens to the position corresponding to the point at which the relative maximum has been detected (step S24).

The control unit 130 analyzes the history of the evaluation values. That is, the control unit 130 analyzes a relation between evaluation values at the relative maximum and evaluation values at the current position of the focus lens, and determines whether a subject image is in-focus or out-of-focus using the aforementioned conditions A and B (step S25).

However, for determining whether the subject is in focus when detecting the absence or presence of malfunction in the video camera, the determination is comprehensively performed not only using the determination result from the above first method for determining whether the subject is in focus (condition A) but also using the determination result from condition B as described later. When the determination of whether the subject is in focus by the above equation 1 in a state of widely wobbling results in an increased possibility of being determined that the subject is out of focus, thereby affecting on the ratio of [the number of determinations in which the focus of the subject is doubtful]/[the number of determinations in which the subject is certainly in focus]. For reducing the contribution of wobbling from the ratio, the determination with the equation 2 using the luminance addition value is performed. Then, the determination of whether the subject is in focus (the determination whether the equation 1 is satisfied) is only performed when the equation 2 is satisfied. That is, an effect of the environmental condition (wobbling) is removed from the above ratio and the ratio is then subjected to the determination with the equation 2 for only referring from the image-processing of the video camera device.

In other words, according to the above-described determination method, only when condition B is satisfied, the determination result of condition A is deemed to be an effective determination result. In other words, condition B determines whether the subject or the like is wobbling (the wobbling is absent if the condition is satisfied) and the result in which the autofocus is completed in the absence of wobbling is regarded as a determination result.

Referring back to the flowchart of FIG. 18 for further description, when the determination process of step S25 as described above completes determination of whether the subject is in focus, the control unit 130 stores the determination result in the memory 131 (step S26).

Subsequently, the control unit 130 updates a number of times (+1) that the results are stored in the memory 131 (step S27). The number of updates is stored in the memory 131. Since the number of times the focal determination (as to whether a subject image is in-focus or out-of-focus) processing conducted is stored, the number of times the subject image being out-of-focus may be computed by subtracting the number of times the subject image being in-focus from the number of times the focal determination processing conducted.

Subsequently, the control unit 130 determines whether or not the number of updates reached a predetermined number (e.g., 1000 times) (step S28). If the number of updates has not reached the predetermined number, the processing at step S28 will terminate.

In the determination processing at step S28, when the number of updates has reached the predetermined number, the control unit 130 retrieves a plurality of determination results from the memory 131, and computes the ratios (proportion) of the retrieved results (step S29). The ratios (proportion) of the determination results are computed in a manner described below.

the control unit 130 stores the respective results of the determination in the memory 131, based on the evaluation values and luminance addition values, and retrieves the results when the number of times that the respective values are stored reaches a predetermined number (e.g., 1000 times). Further, the control unit 130 computes a ratio by dividing the number of times that a subject image being in-focus is determined as unreliable by the number of times that a subject image being in-focus is determined as reliable, and determines whether or not circuits located in the auto-focus mechanism and the related units include abnormal portions, based on the value of resulting ratios. According to this method, whether or not the ratio is a predetermined value or more may be determined, and the histories of a plurality of ratios obtained by previously determined results may also be examined.

For example, if the ratio represents the following change as to 0.01 (first time), 0.02 (second time), 0.011 (third time), and 0.04 (current) in examining the histories of the plurality of ratios obtained by previously determined results, the control unit 130 determines that abnormal processing has occurred in the apparatus (circuits for the auto-focus mechanism, focus drive mechanism and image signal processing circuit, etc.)

Furthermore, on the basis of the ratios (proportion) obtained by the above method, it is determined whether the video camera has any abnormality. The determination of whether the video camera has any malfunction is performed such that a comparison of whether the ratio calculated exceeds a predetermined value as described above is performed or histories of a plurality of ratios obtained in the past is inquired.

Furthermore, the control unit 130 generates warning signals (determination signals) based on the computed ratios or proportion, which are then transmitted to external equipment via respective display units such as an indicator or monitor, or IF unit 170 (step 30).

Finally, the control unit 130 resets (initializes) the update number after outputting the warning signals, and terminates processing (step S31).

When some abnormality is detected in the auto-focus operation, such as deterioration in performance of auto-focus operation or deterioration in image quality, the result of the focal determination may fluctuate. In the aforementioned method, whether or not the auto-focus apparatus exhibits abnormal operation may be determined using the fluctuating factors. The auto-focus mechanism analyzes a relation between evaluation values obtained at the relative maximum and evaluation values obtained when the focus lens is returned to the focus position corresponding to the point at which the peak of the evaluation values have been detected, and assesses reliability of the subject image being in-focus. Therefore, the reliability can be assessed with fluctuation of the evaluation values caused by movement of the subject, thereby improving an accuracy in determining whether or not the auto-focus apparatus exhibits abnormal auto-focus operation.

Moreover, the warning signals may be configured to keep outputting from the control unit 130 to respective units, or may be configured to keep warning for a predetermined period without the user's interference until the user cancels the warning using the user interface (or, operating device). Moreover, the warning may either be effective or ineffective by switching according to the user's setting.

A command signal thus generated with respect to the doubtfulness of malfunctions in the device is transmitted to the CCU 200 to allow not only a photographer of the video camera 100 but also an operator of the CCU 200 to be notified of information about the doubtfulness of malfunctions in the device.

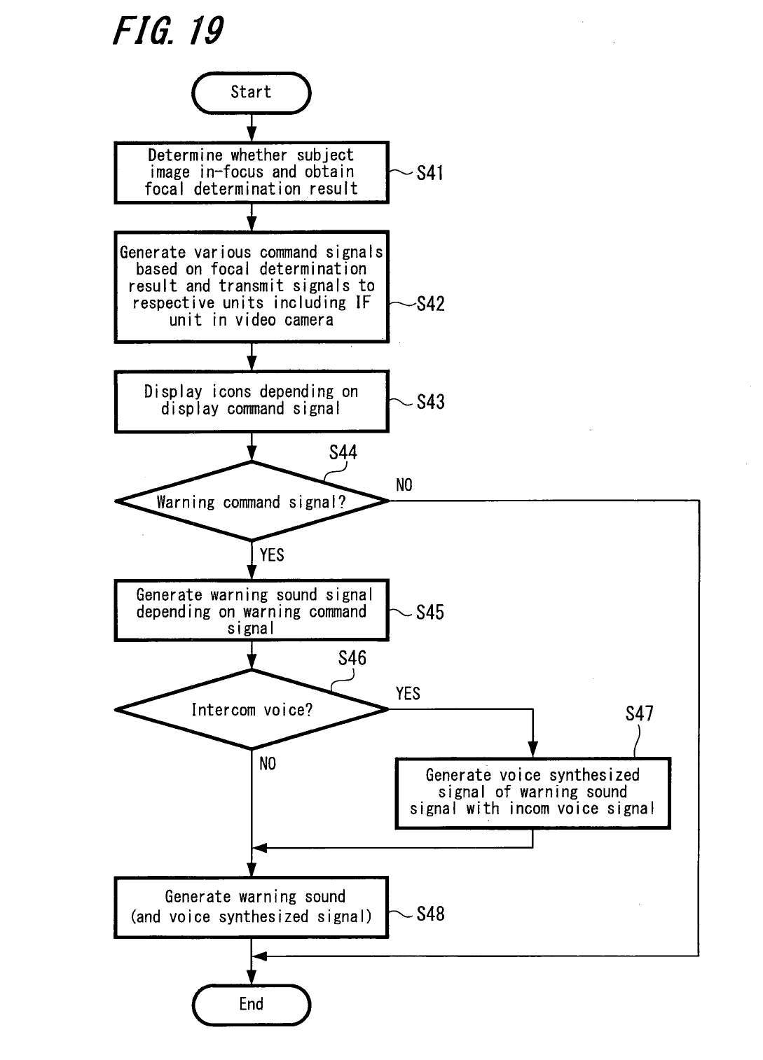

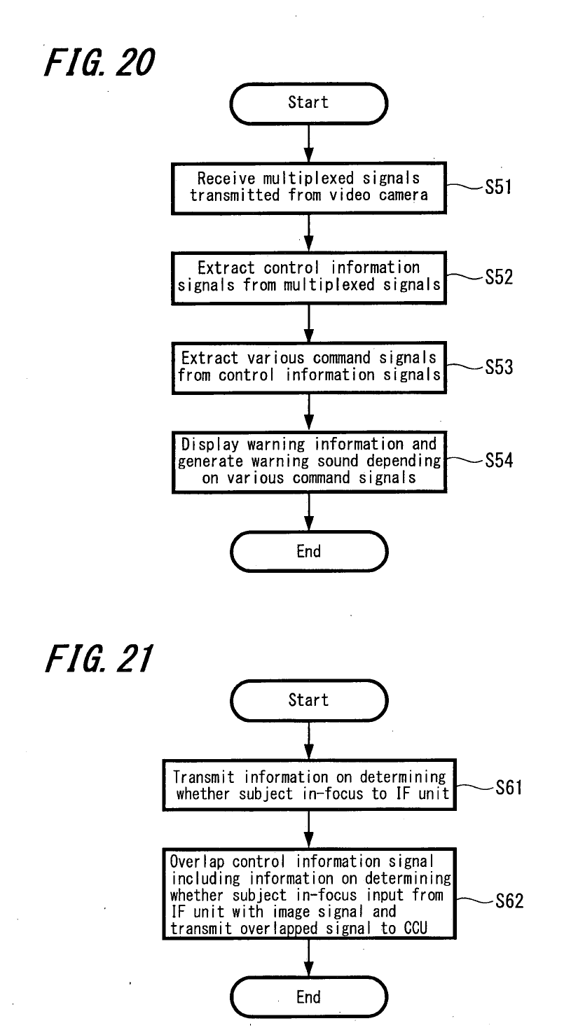

Next, referring now to the flowcharts of FIGS. 19 and 20, examples of the process for transmitting command signals or the like between the video camera and the CCU will be described. FIG. 19 is a flowchart representing an example of the process for transmitting various kinds of command signals in the video camera 100. At first, the method as described above is used to determine whether the subject is in focus (step S41). Subsequently, the control unit 130 generates various kinds of command signals according to the result of determining whether the subject is in focus and then transmits the command signals to the respective units in the video camera 100 and also to the IF unit 170 (step S42). The term “various kinds of command signals” as used herein refers to as display command signals and warning-command signals. In step S43, icons or the like may be displayed on the viewfinder 101 in response to the display command signals.

Next, whether the warning sound generator 180 receives a warning-command signal or not is determined (step S44). If the input is not confirmed, the process is terminated here. If the input of the warning-command signal is confirmed, the warning sound generator 180 selects a warning sound in response to the warning-command signal and then generates a warning-sound signal (step S45). Here, among frequency multiplexed signals received from the CCU 200, whether incom voice signals are multiplexed or not is determined (step S46). If the incom voice signal is confirmed, the incom voice signal is extracted and then combined with a warning sound signal to generate a voice synthesized signal (step S47). Subsequently, the warning sound signal or the voice synthesized signal are output from the incom headphone 103 (step S48)

FIG. 20 is a flowchart representing an example of the process after the CCU 200 receives various kinds of command signals generated in the video camera 100. At first, the frequency discriminator 211 of the CCU 200 receives a frequency multiplexed signal transmitted from the video camera 100 (step S51). Then, a frequency discriminator 211 extracts control information signals from multiplexed signals, followed by transmitting the control information signals to the IF unit 230 (step S52). Subsequently, various kinds of command signals are extracted from the control information signals in the IF unit 230 (step S53). Next, icons or the like for displaying on the external monitor 201 the certainty that the subject is in focus. If the control information signals include warning sound signals, the incom headphone 202 generates a predetermined warning sound (step S54).

Thus, on the basis of the determination information about the certainty that the subject is in focus, various kinds of command signals are generated and then transmitted to the CCU 200, so that the information about the certainty that the subject is in focus may be displayed on the external monitor 200 of the CCU 200 or output as a voice to the incom headphone, so that an operator of the CCU 200 may also be allowed to be notified of the information.

Thus, for example, when the video camera 100 is in a state of out of focus, even if a photographer of the video camera 100 does not recognize such a state, the operator of the CCU 200 is allowed to recognize the state of out of focus.

In such case, the photographer of the video camera 100 is able to be alerted with a voice using the income microphone 203, so that a state of continuously taking pictures with out of focus can be avoided.

Furthermore, during the output of a warning sound from the incom headphone 103 of the video camera 100, the switching of sounds or voices does not occur even if an incom voice is input from the operator of the CCU 200. The incom voice and the warning sound may be overlapped with each other and then output. Therefore, the photographer is allowed to surely recognize an abnormal state, such as out of focus.

Furthermore, in the case where malfunctions or a deteriorated performance of the focus driving is suspected, command signals based on such a situation are generated and then transmitted to the CCU 200 to inform an operator of the CCU 200 about information representing the possibility of malfunctions and deteriorated performance of the focus driving through the external monitor 101 of the CCU 200 or the incom headphone 202.

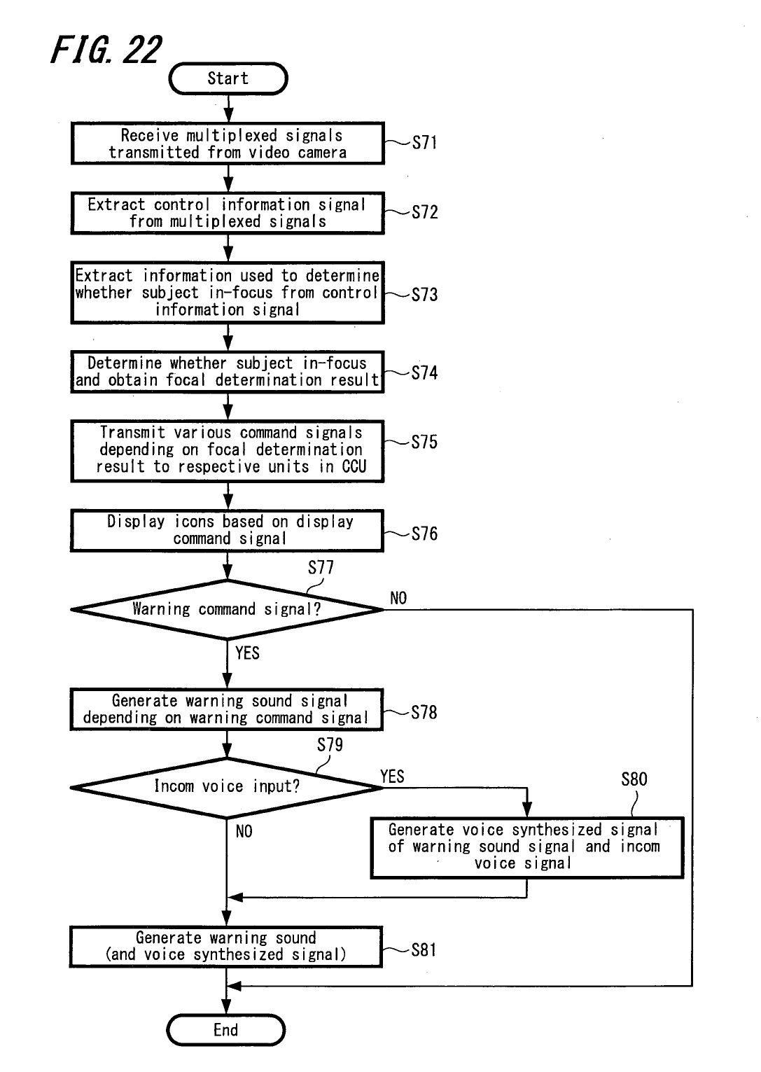

Furthermore, the present embodiment has described the method by which the command signals generated according to the result of determining whether the subject is in focus in the video camera 100 are transmitted to the CCU 200, and information about the certainty that the subject is in focus is displayed or notified with a voice by the CCU 200. Alternatively, the video camera 100 may transmit direct information to be based on determination whether the subject is in focus, such as evaluation values and luminance addition values, and the CCU 200 may determine whether the subject is in focus. An example of the process of the video camera 100 and CCU 200 in this case will be described with reference to the flowcharts of FIGS. 21 and 22.

FIG. 21 is a flowchart for representing an example process for transmitting information about a determination of whether the subject is in focus in the video camera 100. At first, evaluation values, luminance addition values, and so on as information to be based on determination whether the subject is in focus are transmitted to the IF unit 170 (step s61). Then, the evaluation values, the luminance addition values, or the like are overlapped with control signals that represent status information of the respective units of the video camera 100 to generate control information signals. Subsequently, the control information signals are overlapped with image signals by the frequency multiplexer 190 and then transmitted to the CCU 200 through a transmission line 1 (step S62).

FIG. 22 is a flowchart representing an example of the process when the CCU 200 receives from the video camera 100 various kinds of signals to be provided as materials for determining whether the subject is in focus. At first, the frequency discriminator 211 of the CCU 200 receives frequency multiplexed signals transmitted from the video camera 100 (step S71). Then, control information signals are extracted from discriminated signals and then transmitted to the IF unit 230 (step S72). In the IF unit 230, information about evaluation values, luminance addition values, and so on to be provided as materials for determining whether the subject is in focus is extracted from the input control information signals (step S73). Subsequently, a process of determining whether the subject is in focus is performed using evaluation values, luminance addition values, and so on (step S74). Various kinds of command signals are generated according to the contents of the determination and then transmitted to the respective units in the CCU 200 (step S75).

The monitor driver 220 receiving display command signals among the various kinds of command signals selects icons or the like according to the display command signals. Subsequently, image signals are overlapped with the icons or the like and then displayed on the external monitor 201 (step S76). Here, whether a warning-command signal is input in the warning sound generator 180 is determined (step S77). If the input is not confirmed, the process is terminated here. If the input of the warning-command signal is confirmed, the warning sound generator 180 selects a warning sound according to the warning-command signal and then generates a warning sound signal (step S78).

Then, whether incom voice signals are multiplexed in the frequency multiplexed signals received from the camera 100 is determined (step S79). If the incom voice signal is confirmed, the incom voice signal is extracted and then combined with a warning sound signal to generate a voice synthesized signal (step S80). Subsequently, the warning sound signal or the voice synthesized signal are generated from the incom headphone 202 (step S81).

Furthermore, the embodiments of the present invention as described above have been explained as those having configurations in which the video camera is connected with the CCU through the transmission cable. Alternatively, wireless transmission may be performed.

The embodiments of the present invention as described above have been described as those having configurations in which lenses are incorporated in the body of the video camera. Alternatively, they may be configured to use demountable, interchangeable lenses.

It should be understood by those skilled in the art that various modifications, combinations, sub-combinations and alterations may occur depending on design conditions and other factors insofar as they are within the scope of the appended claims or the equivalents thereof.

What is claimed is:

1. An image-capture apparatus including an intercom connecting unit and having an autofocus mechanism, capable of voice communication with an external camera control unit through an intercom connected to the intercom connecting unit, comprising:
an image-capture unit that captures an image of a subject and converts the image into an image signal;
an image signal processor that performs image processing on the signal input from the image-capture unit;
a control unit that determines whether the subject is in focus using the autofocus mechanism and generates a command signal on the basis of a result of the determination; and
a transmitting unit that multiplexes the image signal input from the image signal processor with a control information signal including the command signal input from the control unit on the basis of the result of determining whether the subject is in focus and status information for indicating a state of the image-capture apparatus and transmits multiplexed signals to the camera control unit.

2. An image-capture apparatus including an intercom connecting unit and having an autofocus mechanism, capable of voice communication with an external camera control unit through an intercom connected to the intercom connecting unit, comprising:
an image-capture unit that captures an image of a subject and converts the image into an image signal;
an image signal processor that performs image processing on the signal input from the image-capture unit;
an evaluation value calculator that periodically calculates an evaluation value using a high frequency component of a specific region of the image signal captured by the image-capture unit;
a lens driver that drives a lens so that the image of the subject is in focus;
a control unit that outputs a command value supplied to the lens driver and searches an evaluation value peak while shifting a focus position to detect a relative maximum of the evaluation value, returns the lens to the focus position when the relative maximum is detected to obtain the evaluation value calculated in the evaluation value calculator, determines whether the evaluation value satisfies a predetermined condition, and generates a command signal on the basis of a result of the determination; and
a transmitting unit that multiplexes the image signal input from the image signal processor with a control information signal including the command signal input from the control unit on the basis of the result of determining whether the subject is in focus and status information for indicating a state of the image-capture apparatus and transmits multiplexed signals to the camera control unit.

3. An image-capture apparatus according to claim 2, wherein
the predetermined condition is that, when the relative maximum of the evaluation value is defined as a first evaluation value and the evaluation value when returning the lens to the focus position where the evaluation value becomes the relative maximum is defined as a second value, a value obtained by dividing the second evaluation value by the first evaluation value is larger than a predetermined threshold.

4. An image-capture apparatus according to claim 2, wherein
the control unit generates a warning command signal from the command signal on the basis of the result of determining whether the subject is in focus.

5. An image-capture apparatus according to claim 4, further comprising:
a warning unit that issues a warning on the basis of the warning command signal.

6. An image-capture apparatus according to claim 5, wherein
the warning unit issues the warning by an image display or a voice output.

7. An image-capture apparatus according to claim 2, further comprising:
a voice synthesizer that generates a voice synthesized signal by combining an intercom voice signal input through the intercom with a warning sound signal generated in response to the command signal.

8. An image-capture apparatus according to claim 2, wherein
the transmitting unit multiplexes the image signal input from the image signal processor with the control information signal including information for determining whether the subject is in focus and status information that represents a state of the image-capture apparatus; and then transmits multiplexed signals to the camera control unit.

9. An image-capture apparatus including an intercom connecting unit and having an autofocus mechanism, capable of voice communication with an external camera control unit through an intercom connected to the intercom connecting unit, comprising:
an image-capture unit that captures an image of a subject and converts the image into an image signal;
an image signal processor that performs image processing on the signal input from the image-capture unit;
an evaluation value calculator that periodically calculates an evaluation value using a high frequency component of a specific region of the image signal captured by the image-capture unit;
a luminance addition value calculator that calculates a luminance addition value by integrating a luminance of a specific region of the image signal;
a lens driver that drives a lens so that the image of the subject is in focus;
a control unit that outputs a command value supplied to the lens driver and searches an evaluation value peak while shifting a focus position to detect a relative maximum of the evaluation value, returns the lens to the focus position when the relative maximum is detected to obtain the evaluation value calculated in the evaluation value calculator and the luminance addition value calculated in the luminance addition value calculator, determines whether the evaluation value satisfies a first condition, determines whether the luminance addition value satisfies a second condition, and generates a command signal on the basis of results of the determinations; and
a transmitting unit that multiplexes the image signal input from the image signal processor with a control information signal including the command signal input from the control unit on the basis of the result of determining whether the subject is in focus and status information for indicating a state of the image-capture apparatus and transmits multiplexed signals to the camera control unit.

10. An image-capture apparatus according to claim 9, wherein
the first condition is that, when the relative maximum of the evaluation value is defined as a first evaluation value and an evaluation value when returning the lens to the focus position where the evaluation value becomes the relative maximum is defined as a second value, a value obtained by dividing the second evaluation value by the first evaluation value is larger than a predetermined threshold; and
the second condition is that, when the luminance addition value at the time of detecting the relative maximum of the evaluation value is defined as a first luminance addition value and the luminance addition value at a predetermined number of fields prior to the time of detecting the relative maximum is defined as a second luminance addition value, a value obtained by dividing the second luminance addition value by the first luminance addition value is within a predetermined range.

11. An image-capture apparatus according to claim 9, further comprising:
a warning unit that issues a warning on the basis of the warning command signal.

12. An image-capture apparatus according to claim 11, wherein
the warning unit issues the warning by an image display or a voice output.

13. An image-capture apparatus according to claim 12, further comprising:
a voice synthesizer that generates a voice synthesized signal by combining an intercom voice signal input through the intercom with a warning sound signal generated in response to the command signal.

14. An image-capture apparatus according to claim 9, wherein
the transmitting unit multiplexes the image signal input from the image signal processor with the control information signal including information for determining whether the subject is in focus and status information that represents a state of the image-capture apparatus; and then transmits multiplexed signals to the camera control unit.

15. A camera control unit that receives an image signal from a connecting image-capture apparatus having an autofocus mechanism, controls the image-capture apparatus transmitting the image signal, and performs a voice communication with an intercom connected to the image-capture apparatus, comprising:
a receiving unit that receives multiplexed signals transmitted from the image-capture apparatus and extracts from the multiplexed signal the image signal and a control information signal including a command signal on the basis of a result of determining whether the subject is in focus and status information for indicating a state of the image-capture apparatus; and
a control unit that extracts the command signal on the basis of the result of determining whether the subject is in focus from the control information signals extracted in the receiving unit and issues a warning in response to the result of determining whether the subject is in focus.

16. A camera control unit according to claim 15, wherein
the control unit issues the warning by an image display or a voice output.

17. A camera control unit according to claim 15, further comprising:
a voice synthesizer that generates a voice synthesized signal by combining an intercom voice signal input through the intercom with a warning sound signal generated in response to the command signal.

18. A camera control unit according to claim 15, wherein
when the command signal on the basis of the result of determining whether the subject is in focus is not included in the control information signal, the control unit determines whether the subject is in focus using information, which is included in the control information signal, for determining whether the subject is in focus and generates a command signal according to a result of the determination, while issuing a warning corresponding to the command signal.

19. A video camera system, comprising an image-capture apparatus having an autofocus mechanism capable of connecting to an intercom and a camera control unit that controls the image-capture apparatus,
wherein the image-capture apparatus includes
an image-capture unit that captures an image of a subject and converts the image into an image signal;
an image signal processor that performs image processing on the signal input from the image-capture unit;
a control unit that determines whether the subject is in focus and generates a command signal on the basis of a result of the determination; and
a transmitting unit that combines the image signal input from the image signal processor with the command signal input from the control unit and a control information signal indicating a state of the image-capture apparatus and transmits multiplexed signals to the camera control unit, and
wherein the camera control unit includes
a receiving unit that receives the multiplexed signals transmitted from the image-capture apparatus and extracts from the multiplexed signal the image signal and the command information signal including the command signal based on the result of determining whether the subject is in focus; and
a control unit that extracts the command signal on the basis of the result of the determination of whether the subject is in focus from the control information signal extracted in the receiving unit and issues a warning in response to the command signal in response to the result of determining whether the subject is in focus.

20. A method of transmitting control information between an image-capture apparatus and a camera control unit that controls the image-capture apparatus, comprising the steps of:
on the image-capture apparatus,
determining whether the subject is in focus and generating a command signal on the basis of a result of the determination,
multiplexing an image signal with the command signal on the basis of the result of determining whether the subject is in focus and a control information signal indicating a state of the image-capture apparatus, and
transmitting multiplexed signals to the camera control unit; and
on the camera control unit,
receiving the multiplexed signal,
extracting from the multiplexed signal the image signal and the command signal on the basis of the result of determining whether the subject is in focus, and
issuing a warning depending on the command signal.
